(19) United States
(12) Patent Application Publication
(10) Pub. No.: US 2022/0402224 A1
(43) Pub. Date: Dec. 22, 2022

(54) BUILD TEMPERATURE CONTROL

(71) Applicant: Hewlett-Packard Development Company, L.P., Spring, TX (US)

(72) Inventors: Alejandro Manuel de Pena Hempel, Sant Cugat del Valles (ES); Pol Fornos Martinez, Sant Cugat del Valles (ES); Ismael Fernandez Aymerich, Sant Cugat del Valles (ES)

(21) Appl. No.: 17/772,475

(22) PCT Filed: Oct. 29, 2019
(86) PCT No.: PCT/US2019/058490

§ 371 Date: Apr. 27, 2022

(51) Int. Cl. B29C 71/02; B29C 64/393; B33Y 30/00; B33Y 40/20

(52) U.S. Cl. CPC B29C 71/02; B29C 64/393; B33Y 30/00; B33Y 40/20

(57) ABSTRACT

There are disclosed methods and devices for build temperature control. In some examples, a method comprises applying a temperature controllable top cover over a top of the build volume. The method may further comprise controlling the temperature controllable top cover to maintain a temperature substantially equal to a build temperature for a predetermined period of time. The method may further comprise applying a thermally conductive bottom cover to a bottom of the build volume.

### BACKGROUND

Additive manufacturing systems may generate three-dimensional objects on a layer-by-layer basis through the selective solidification of a build material. In examples of such techniques, build material is supplied in a layer-wise manner and a solidification method may include heating the layers of build material to cause melting in selected regions, for example in regions bearing a fusing agent. In other techniques, other solidification methods, such as chemical solidification methods or binding materials, may be used.

### BRIEF DESCRIPTION OF DRAWINGS

Non-limiting examples will now be described with reference to the accompanying drawings, in which:

FIG. 1 is a flowchart of a method according to some examples;

FIGS. 2a and 2b are examples including line charts of thermal trajectories;

FIG. 3 is a flowchart of a further method according to some examples;

FIG. 4 is a simplified schematic of a device according to some examples;

FIG. 5 is a simplified schematic of a device according to some examples;

FIG. 6 is a flowchart of a further method according to some examples;

and

FIG. 7 is a simplified schematic of a further device according to some examples.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print or build bed and processed layer by layer, for example within a fabrication chamber. According to one example, a suitable build material may be PA12 build material commercially referred to as V1R10A “HP PA12” available from HP Inc.

In some examples, selective solidification is achieved using heat in a thermal fusing additive manufacturing operation. This may comprise directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

Heat applied to specific locations on the outer surfaces of a build volume may be controlled to improve consistency of the heat applied over the build volume as a whole. For example, as the manufacturing process is carried out, the build volume, built on a layer-by-layer basis, may be subjected to elevated temperatures within a build unit. The first layer may be subjected to these elevated temperatures for the longest time of all the layers and the final layer for the shortest time. This difference in time spent at elevated temperatures may lead to differences in the crystalline structure of re-solidified material, meaning that parts, within the build, manufactured towards the start of the build may have different mechanical and dimensional properties to those manufactured towards the end of the build. In accordance with some examples, separate application of heat after the manufacturing process is complete, during the “cooling phase”, may help to reduce these mechanical and dimensional differences, as described below.

In some examples, there are provided methods and devices for improving the thermal characteristics of a 3D print or build volume leading to manufactured parts with superior properties. More specifically, examples may relate to ways of increasing the consistency of the temperatures applied to the whole of a build volume. The temperatures experienced by a build volume, or a portion of a build volume, over time may be described as the “thermal trajectory” or the “thermal pattern” thereof. Each location within the build volume may have a different thermal trajectory. For example, during an additive manufacturing process, a build volume may be subjected to energy in the form of heat either as part of the manufacturing process, which may be hyper-localised based on the nature of the build, or external, i.e. applied to the outer surfaces of the build volume. In some examples, controlling the heat applied to the outer surfaces of the build volume may improve the consistency of the mechanical characteristics of parts in the build volume.

For example, a first layer may be subjected to temperatures of around 120° C. for around 14 hours (the amount of time may be dictated by the number of layers in a build and time taken for each layer to be deposited) during a manufacturing process. This temperature may be appropriate for polypropylene, PP. However, other temperatures may be appropriate for other materials. For example, for polyamide, PA12, a temperature of 160° C. may be appropriate. Therefore, by the end of the manufacturing process, the first layer may have experienced this temperature, in addition to any specific energy applied during manufacture, for approximately the whole build time, or 14 hours, for example. Therefore, in order to improve the consistency of the temperatures applied to the build as a whole, and hence bring the thermal trajectory of the last layer closer to that of the first layer, post-build processing may be carried out as described below.

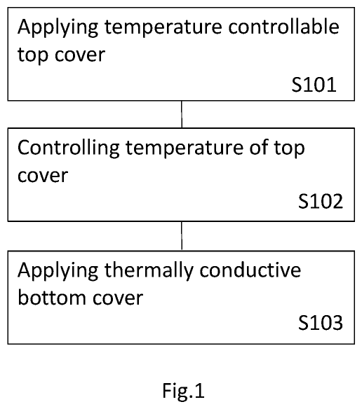

In accordance with some examples described herein, and as shown in FIG. 1, there is provided a method for post-print/post-build processing of a build volume created by additive manufacturing. The method may comprise applying S101 a temperature controllable top cover over or to a top of the build volume. The method may further comprise, controlling S102 the temperature controllable top cover to maintain a temperature substantially equal to a build temperature or build temperature for a predetermined period of time. The method may further still comprise applying S103 a thermally conductive bottom cover to a bottom of the build volume.

In some examples, a completed build volume may have a substantially cuboidal shape, where a bottom surface may rest on a build bed. Four side surfaces may be surrounded by walls of a build unit. A top surface may be left exposed. The build volume may then be removed from the build unit by sliding a bottom cover, which may for example be a sheet of metal, along the surface of the build bed in a guillotine-style movement, such that the build volume then rests on the bottom cover. The build bed and build unit walls may be maintained at a specific temperature during the build. After the last layer of the build is applied to the build volume (deposited or printed), the temperature controllable top cover may be placed on the top of the build volume, so that the top surface may be heated or cooled according to the temperature of the top cover. The top cover may preferably be controlled to heat the top surface of the build volume to the same temperature as is applied to the sides and bottom surface of the build volume. That is to say, the top cover may be maintained at substantially the same temperature as the temperature at which the side walls and the build bed are maintained. Thus, all surfaces of the build volume may be exposed to the same temperature. As detailed above, the lower parts of the build volume will have been subjected to these temperatures for longer. Therefore, at this stage, the build volume may be moved from the build unit to a cooling unit, with the top cover still in place and still applying the same heat thereto. In some examples, the temperature controllable top cover may be a metallic plate, which may be controllable to heat up (or cool down) in a homogenous manner. In some examples, the temperature controllable top cover may be a movable platform, which may be moved to the correct position over build volumes of differing build depths.

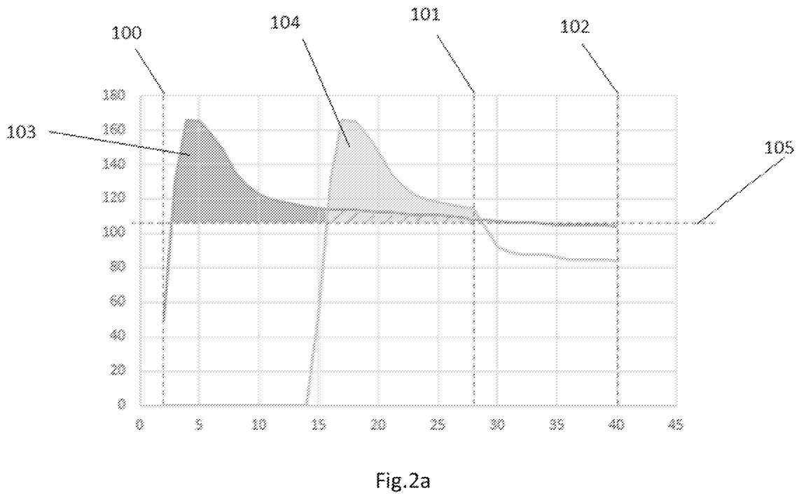

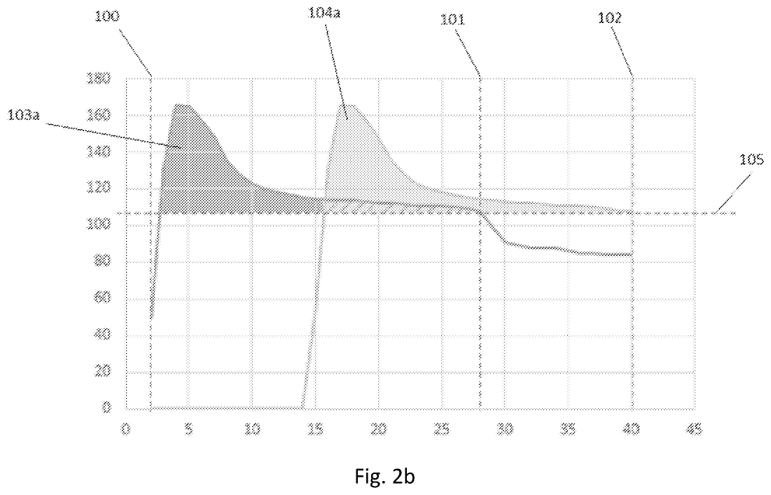

In some examples, as shown in FIGS. 2a and 2b, while in the build unit the lower layers of the build volume may experience a similar thermal trajectory to the upper layers, but at different times. In FIGS. 2a and 2b, representative temperatures (values shown on the ordinate/Y-axis in Celsius/centigrade) and representative time (values shown on the abscissa/X-axis in minutes) are shown. The upper layers, having been deposited later, may experience the higher temperatures later and for less time, and thus the thermal trajectories of the two may differ once the build is complete. FIGS. 2a and 2b show the start of the build process 100, the end of the build process/start of the cooling phase 101 and end of the cooling phase 102.

As shown in FIG. 2a, an example is given in which no top cover or bottom cover is applied to the build volume. In this example, a first temperature rise 103 is experienced which shows a steep increase in temperature following the start of building/additive manufacturing 100. This first temperature rise 103 is representative of the thermal trajectory experienced by lower layers in the build volume, which are deposited earlier during the build. The horizontal line 105 may represent the “build temperature” (for example T_{build}), which may be the temperature around the build volume, within the build unit. Temperatures higher than the build temperature may be experienced during the build process, as higher temperatures may be appropriate to melt/fuse build material together. As shown, the temperatures experienced by the lower layers taper off towards the build temperature. The second temperature rise 104 is representative of the thermal trajectory experienced by the upper layers in the build volume, which are deposited later during the build.

The thermal trajectories of the upper and lower layers of build material may be similar until the build process is finished. Post-build processing, which may in some examples be referred to as the cooling phase, may involve transferring the build volume from the build unit to a cooling unit. When transferring the build volume, the bottom and side surfaces of the build volume may be surrounded by thermally insulating material (in practice these may be the surfaces defining the boundaries of the build area, which is then filled by the build volume during the build process). The top surface may however be exposed to ambient conditions, without any insulation, leading to a relatively sharp drop in the temperature of the upper layers within the build volume, whereas the lower layers, being surrounded by thermally insulting material, may experience a much slower cooling.

Turning to FIG. 2b, an example is given in which a top cover and a bottom cover are applied to the build volume as described above. In this example, in the phases up until the build process is finished, the thermal trajectories of the upper and lower layers are approximately the same. However, after the build process is finished the path of the respective thermal trajectories is different. Lower layers 103a, following application of the thermally conductive bottom cover, experience an increased cooling due to the transfer of heat energy through the bottom cover. The temperature controllable top cover may be maintained at a temperature approximately equal to the horizontal line 105, i.e. the build temperature, Upper layers 104a, following application of the temperature controllable top cover, may experience a much more gradual cooling. In this way, the lower and upper layers of build material may have very similar thermal trajectories.

In some examples described herein, it is possible to control the temperature of the different parts or layers of the build volume once a build process is completed by the addition of a temperature controllable surface or cover to be placed on top of the finished build volume and/or by exposing the lower part of the build volume to more thermally conductive materials at ambient conditions. In this way, the part of the build volume that has experienced the elevated temperatures for longer may be cooled more quickly and the part of the build volume that has experienced a relatively short period at the elevated temperature may be maintained at the elevated temperature until both parts have been heated for approximately the same amount of time, and thus follow a similar thermal trajectory.

Once the build process is finished, the build volume may be moved into a separate area during a cooling phase. During the cooling phase, the bottom and side surfaces of the build volume may be exposed to ambient conditions, i.e. room temperature rather than the temperature within the build unit.

A build temperature, T_{build}, may be different for different materials. In one example, the build temperature for polypropylene may be approximately 120° C. The build temperature may however be any suitable temperature for carrying out the build process. The build temperature may refer to the temperature to which the build material is heated prior to a fusing agent being applied to the layer during the build process. For example, the build temperature may lie within a range of temperatures suitable for the build process. The predetermined amount of time may for example be an amount of time to achieve predetermined part characteristics. In some examples, the predetermined amount of time may be based on the amount of time the bottom or lower part of the build volume has spent at or near the build temperature. In some examples, the thermally conductive bottom cover may for example be made of metal, such as aluminium, having a thermal conductivity of around 200 W/m K.

In some examples, after the predetermined period of time has elapsed, the method may further comprise controlling the temperature controllable top cover to follow a thermal trajectory of the bottom of the build volume.

In accordance with some examples, the temperature of the top of the build volume may be controlled to mimic the temperatures experienced by the bottom of the build volume. In this way, both the time spent at the build temperature and the subsequent thermal trajectory at lower temperatures may be mimicked, in order to further improve the consistency of the thermal trajectories of the upper and lower build layers. Improvements in the consistency of the thermal trajectories experienced by the different build layers may improve the properties of the parts made by the build process. Applying the appropriate amount of heat to the build volume and the layers of the build volume, and thus to parts in the build volume, may improve the crystalline structure of the material in the parts.

Asymmetric cooling and the associated difference in thermal trajectories for each of the layers, and thus the parts generated across those layers, in a build volume may lead to unintended thermal gradients and affect the crystalline structure of the re-solidified build material and its consolidation process, yielding differences in mechanical and dimensional properties inside the same build. Therefore, by improving the symmetry of the heating and cooling for the top and bottom of the build volume, more consistent parts may be produced and part quality may be improved.

In some examples, the temperature controllable top cover may be applied before placing the build volume into a cooling unit. For example, after the last layer of the build is applied to the build volume (deposited or printed), the temperature controllable top cover may be placed or lowered onto the top of the build volume, so that the top surface may be heated or cooled according to the temperature of the top cover. Following completion of a build process therefore, the build volume may be cooled in a controlled manner. For this purpose, a cooling unit, separate to the build unit, may be provided into which the build volume may be placed during the cooling phase. Avoiding any cooling of the top of the build volume may ensure that the thermal trajectories of the top and bottom of the build volume remain closely aligned. The top of the build volume may be maintained at the elevated temperature, rather than being subjected to a slight cooling and then re-heating when the top cover is applied. Therefore, interim cooling may be reduced by applying the temperature controllable top cover before placing the build volume into a cooling unit. During the cooling phase the top of the build volume may still be heated by the top cover, for a specific period and then cooled in a controlled manner.

In some examples, the thermally conductive bottom cover may be temperature controllable. According to some examples, the method may further comprise controlling a temperature of the bottom cover. Providing a temperature controllable bottom cover may allow from the thermal trajectory of the lower layers of a build volume to be improved, based on the nature of the parts being produced in the build. The top cover may be controlled to follow the thermal trajectory of the lower layers of the build volume, taking the influence of the temperature controllable bottom cover into account.

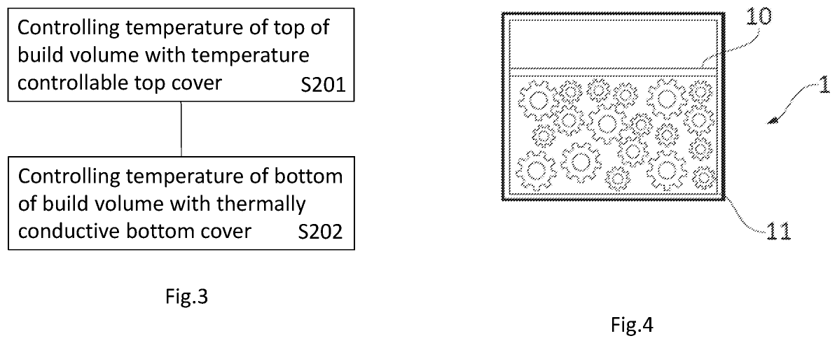

In accordance with some examples described herein, and as shown in FIG. 3, there is provided a method. The method may comprise controlling S201 a temperature of a top of a build volume. The build volume may be created by an additive manufacturing process. The temperature control may be performed by applying a temperature controllable top cover to the top of the build volume and setting the temperature controllable top cover to a specific temperature. The specific temperature may for example be the build temperature described above The method may further comprise controlling S202 or regulating a temperature of a bottom of the build volume by applying a thermally conductive bottom cover to the bottom of the build volume and exposing the bottom cover to ambient conditions. Applying the thermally conductive bottom cover may improve heat transfer away from the build volume. In this way, through the application of the thermally conductive bottom cover the bottom of the build volume may be cooled.

In some examples, thermal symmetry between the top and the bottom of the build volume may be improved. The top of the build volume may for example refer to the top surface or the top part, such as approximately the top third of the build volume. The bottom of the build volume may for example refer to the bottom surface or the bottom part, such as approximately the bottom third of the build volume.

In some examples, the method may further comprise detecting a temperature of the bottom of the build volume. Detecting or measuring the temperature of the bottom of the build volume may improve the control of the temperature applied to the top of the build volume. Recording the detected temperatures over a period of time may allow a thermal trajectory or thermal pattern for the bottom of the build volume to be created, which may be used to apply a similar thermal trajectory to the top of the build volume. The method may therefore further comprise controlling the temperature controllable top cover to follow a thermal pattern substantially matching that of a bottom surface of the build volume. The temperature may be detected by a sensor or set of sensors. A sensor may be any sensor capable of sensing temperature, such as a thermal imaging device, an infrared (IR) sensor, a thermal camera, thermocouples or the like. Although examples of sensors are provided, it will be understood that other sensors may be used for sensing temperature. In some examples, a combination of different sensors may be used for sensing temperature.

In some examples, the temperature controllable top cover may be applied after the build process is complete and before placing the build volume into a cooling unit.

A cooling unit may be provided to ensure cooling of the build volume occurs at an appropriate rate. The top cover may be applied before the build volume is placed in the cooling unit to continue to heat the build volume for a period of time before being placed in, and while in, the cooling unit.

In some examples, the temperature controllable top cover remains in position on top of the build volume until the build volume cools to ambient conditions.

In some examples the top cover may be left in place, so as to avoid the need to open the cooling unit during cooling to remove the top cover. Further, maintaining the top cover in place may allow for the thermal trajectory of the top of the build volume to be monitored and adjusted, by controlling the top cover, in order to avoid deviations from the intended thermal trajectory.

In accordance with some examples, and as shown in FIG. 4, there is provided a device 1. The device 1 may comprise a temperature controllable top cover 10 to be applied over a top surface of a build volume. The device 1 may further comprise a thermally conductive bottom cover 11 to be applied to a bottom surface of the build volume, wherein, in use, the thermally conductive bottom cover 11 is in contact with the build volume on one side and is exposed to ambient conditions on another side, opposite the one side. In FIG. 4, the build volume is depicted with a representation of additive manufactured parts within the build volume. This is merely for demonstrative purposes and may in some examples be obscured in the build volume. The device 1 may be described as a temperature regulation system for regulating the temperature of a build volume.

Providing a thermally conductive bottom cover 11 directly in contact with the build volume may increase the efficiency of the cooling effect to bring the build volume down to ambient conditions more quickly. The bottom cover 11 may be made of metal and may for example be used to remove the build volume from the build bed. For example, the bottom cover 11 may be slid between the build volume and the build bed, and used to move the build volume to a cooling unit.

In some examples, a build depth of the build volume is less than or equal to approximately 0.2 m. Having a build volume with a distance between the top surface and the bottom surface of 20 cm or less may improve the consistency of the thermal characteristics over the whole build volume. As heat is applied from the outside to the surfaces of the build volume, it may take longer for the heat to reach the centre of a deeper build volume. A build depth of 20 cm or less has been shown to produce good homogenous thermal characteristics over the build volume using the methods and devices of the described examples.

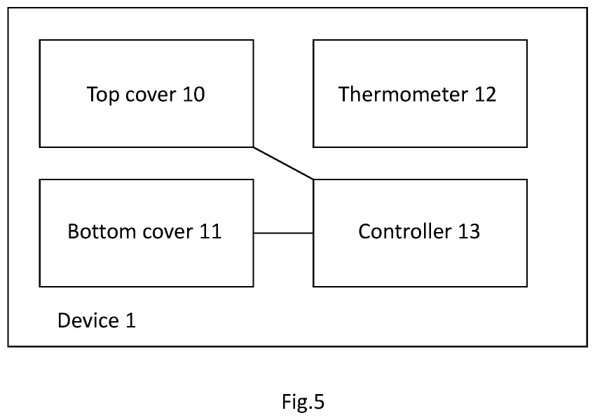

In some examples, as shown in FIG. 5, the thermally conductive bottom cover 11 is temperature controllable. In accordance with the examples, the device 1 may further comprise a controller 13 to control the temperature of the thermally conductive bottom cover 11 and/or the temperature controllable top cover 10. In other examples, separate controllers may be provided to control the top cover 10 and bottom cover 11 separately. In some further examples, the device 1 may further comprise a thermometer or other temperature sensor 12 to detect the temperature of the bottom surface of the build volume.

Measuring the temperature of the bottom surface of the build volume may allow for more accurate recording of the thermal trajectory of the build volume. In some examples, the temperature controllable top cover is controllable to follow a thermal pattern substantially matching that of the bottom surface of the build volume, based on the detected temperature. Providing the top of the build volume with the same thermal trajectory as the bottom may improve the homogeneity of the characteristics of the parts produced in the build volume.

In some examples, the temperature controllable top cover is controllable to follow a thermal pattern substantially matching that of the bottom surface of the build volume, based on a calculated thermal trajectory of the bottom surface.

The thermal trajectory of the bottom surface may be calculated accurately based on the temperatures applied during the build process.

In some examples, the controller 13 is to control the temperature of the temperature controllable top cover 10 based on the calculated thermal pattern of the bottom surface. In some examples, the controller 13 is to control the temperature of the temperature controllable top cover 10 based on the detected temperature of the bottom surface.

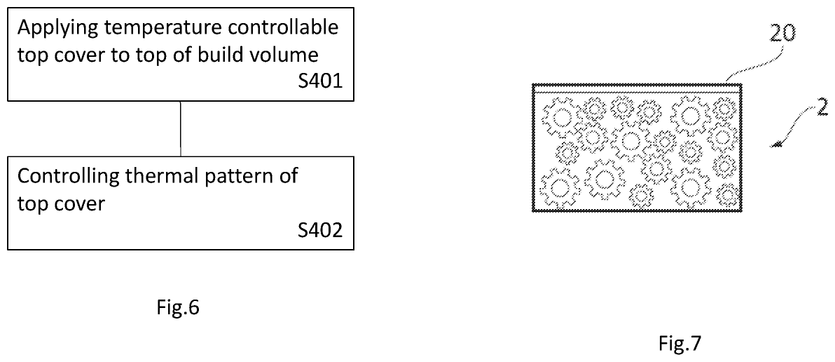

In accordance with some examples, and as shown in FIG. 6, there is provided a method. The method may comprise applying S401 a temperature controllable top cover over a top surface of a build volume. The method may further comprise controlling S402 the top cover to follow a thermal pattern substantially matching that of a bottom surface of the build volume.

Applying heat to the top of the build volume which is consistent with the heating experienced by the bottom of the build volume may improve the consistency of the build process for all parts in the build and thus improve the quality of the parts produced in that build. The bottom part of the build volume will inevitably experience more heating as part of the build process as additive manufacturing techniques may involve building layers of build material from a build bed up.

In accordance with some examples described herein, and as shown in FIG. 7, there is provided a device 2. The device 2 may comprise a temperature controllable top cover 20 to be applied over a top surface of a build volume, created by an additive manufacturing process, wherein the top cover 20 is controlled to follow a thermal pattern substantially matching that of a bottom surface of the build volume. In FIG. 7, the build volume is depicted with a representation of additive manufactured parts within the build volume. This is merely for demonstrative purposes. The device 2 may also be described as a temperature regulation system for regulating the temperature of a build volume.

In some examples, the bottom part of the build volume may experience a suitable thermal trajectory meaning no additional heating or cooling may be appropriate. Consistency between the thermal trajectory of the bottom part and that of the top part of the build volume may lead to more consistent quality of parts produced by the build and post-build processing.

In some examples, a build depth of the build volume is less than or equal to approximately 0.2 m. Having a build volume with a distance between the top surface and the bottom surface of 20 cm or less may improve the consistency of the thermal characteristics over the whole build volume.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the scope of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for post-build processing of a build volume created by additive manufacturing, the method comprising:
applying a temperature controllable top cover over a top of the build volume;
controlling the temperature controllable top cover to maintain a temperature substantially equal to a build temperature for a predetermined period of time; and
applying a thermally conductive bottom cover to a bottom of the build volume.

2. The method of claim 1, wherein
after the predetermined period of time has elapsed, controlling the temperature controllable top cover to follow a thermal trajectory of the bottom of the build volume.

3. The method of claim 1, wherein
the temperature controllable top cover is applied before placing the build volume into a cooling unit.

4. The method of claim 1, wherein
the thermally conductive bottom cover is temperature controllable, the method further comprising:
controlling a temperature of the bottom cover.

5. A method comprising:
controlling a temperature of a top of a build volume, created by an additive manufacturing process, by applying a temperature controllable top cover to the top of the build volume and setting the temperature controllable top cover to a specific temperature;
controlling a temperature of a bottom of the build volume by applying a thermally conductive bottom cover to the bottom of the build volume and exposing the bottom cover to ambient conditions.

6. The method of claim 5, further comprising:
detecting the temperature of a bottom surface of the build volume; and
controlling the temperature controllable top cover to follow a thermal pattern substantially matching that of the bottom surface of the build volume.

7. The method of claim 5, further comprising:
applying the temperature controllable top cover after the additive manufacturing process is complete and before placing the build volume into a cooling unit.

8. The method of claim 5, wherein
the temperature controllable top cover remains in position on top of the build volume until the build volume cools to ambient conditions.

9. A device comprising:
a temperature controllable top cover to be applied over a top surface of a build volume, created by an additive manufacturing process, wherein the top cover is controlled to follow a thermal pattern substantially matching that of a bottom surface of the build volume.

10. The device of claim 9, wherein
a build depth of the build volume is less than or equal to approximately 0.2 m.

11. The device of claim 9, wherein
the thermally conductive bottom cover is temperature controllable.

12. The device of claim 9, further comprising:
a thermometer to detect the temperature of the bottom surface of the build volume; wherein
the temperature controllable top cover is controllable to follow the thermal pattern substantially matching that of the bottom surface of the build volume, based on the detected temperature.

13. The device of claim 9, wherein
the temperature controllable top cover is controllable to follow a thermal pattern substantially matching that of the bottom surface of the build volume, based on a calculated thermal pattern of the bottom surface.

14. The device of claim 13, further comprising:
a controller to control the temperature of the temperature controllable top cover based on the calculated thermal pattern of the bottom surface.

15. The device of claim 12, further comprising:
a controller to control the temperature of the temperature controllable top cover based on the detected temperature of the bottom surface.
